(19) United States
(12) Patent Application Publication
(10) Pub. No.: US 2019/0176678 A1
(43) Pub. Date: Jun. 13, 2019

(54) TRANSPORT TRAILER WITH MOVABLE COMPONENTS FOR IMPROVED USER MOBILITY THEREON

(71) Applicant: Kart Performance Trailers, Kuusalu alevik (EE)

(72) Inventors: Rauno LUKKA, Kuusalu alevik (EE); Rasmus TUVIKENE, Kuusalu alevik (EE); Janno TOOMING, Kuusalu alevik (EE)

(21) Appl. No.: 16/211,598

(22) Filed: Dec. 6, 2018

Related U.S. Application Data
(60) Provisional application No. 62/596,306, filed on Dec. 8, 2017.

(51) Int. Cl. B60P 3/08; B60P 3/07; B60P 1/273

(52) U.S. Cl. CPC B60P 3/08; B60P 1/273; B60P 3/07

(57) ABSTRACT

Convertible transport trailers having upper and lower decks for positioning automobiles thereon for transportation and further having deployable and stowable components allowing easier user maneuverability to move about the trailer especially after parking the automobile thereon. In certain aspects, the trailers include deployable and stowable components including a catwalk assembly positioned on the upper and/or lower deck of the trailer and a pair of stanchions that are rotatable about a horizontal axis, each of which allow for easier user maneuverability to move about the trailer after parking the automobile thereon.

### TECHNICAL FIELD

The present invention relates generally to the field of transport trailers, and more particularly, to transport trailers having upper and lower decks for securely positioning automobiles and/or transfer trucks thereon for subsequent transportation to a desired location. These transport trailers further have deployable and stowable components allowing one to selectively increase trailer width (e.g., trailer deck width) for easier user maneuverability to move about the trailer, especially after parking the automobile and/or transfer truck thereon, when compared to conventional transport trailers.

### BACKGROUND

Open-frame trailers are currently used for transporting automobiles and large transfer trucks. These trailers may include a single deck configuration or a double decker configuration that includes an upper deck positioned immediately above a lower deck. Double decker trailers have particularly gained favor over the past twenty to thirty years because these configurations allow for efficient transport of a higher number of automobiles or large transfer trucks thereon to a desired location when compared to trailers having a single deck configuration.

Although current double decker trailer configurations allow for the efficient transport of a high number of automobiles or large transfer trucks thereon to a desired location, several problems exist. For example, trailer width is limited due to lane width of the roads that these trailers travel on. Limited trailer width is especially problematic in current double decker trailer configurations because one has little or no room to maneuver freely about the upper deck after parking an automobile or large transfer truck thereon but before transporting the automobile(s) or large transfer truck(s) to the desired location. Likewise and even when parking an automobile or large transfer truck on the lower deck of the double decker trailer, maneuverability is limited due to the presence of large support beams (stanchions) that attach, connect, and support the upper deck to the lower deck.

### BRIEF SUMMARY

Therefore, a need exists to provide trailers that allow freer and easier mobility/maneuverability after parking an automobile or large transfer truck thereon. Disclosed are transport trailers having upper and lower decks for securely positioning automobiles thereon for transportation and further having deployable and stowable components allowing one to selectively increase trailer width (e.g., trailer deck width) for easier user maneuverability to move about the trailer especially after parking the automobile thereon. In certain aspects, the trailers include deployable and stowable components including a catwalk assembly positioned on the upper and/or lower deck(s) of the trailer and a pair of stanchions that are rotatable about a horizontal axis, each of which allows for easier user maneuverability to move about the trailer after parking the automobile thereon.

Specifically disclosed herein are transport trailers configured to securely transport automobiles and/or transfer trucks thereon. The trailer(s) include a rigid lower deck for parking and transporting automobiles and/or transfer trucks thereon, the lower deck having a first end configured for attachment to a movement means (i.e., a large transfer truck) and a ramp positioned at the opposite end of the lower deck relative to the first end that is configured to receive and load automobiles and/or transfer trucks thereon; and a rigid upper deck for parking and transporting automobiles and/or transfer trucks thereon that is mounted onto the rigid lower deck by a first pair of vertically adjustable stanchions proximate to the first end of rigid lower deck and a second pair of vertically adjustable and horizontally rotatable stanchions that are spaced apart from the first pair of vertically adjustable stanchions along the longitudinal axis of the trailer (and distal to the first end of the rigid lower deck relative to the first pair of vertically adjustable stanchions), the rigid upper deck having a first end that extends beyond the first end of the rigid lower deck and a ramp positioned at the opposite end of the rigid upper deck relative to a first end of the rigid upper deck that is vertically adjustable by the second pair of vertically adjustable and horizontally rotatable stanchions to load automobiles thereon.

In certain aspects, the rigid upper deck includes two spaced apart elongate side girders that are connected by a planar, rigid material positioned there between, the planar, rigid material is configured to support automobile(s) and/or transfer trucks thereon.

In certain aspects, a catwalk assembly is attached to an outermost peripheral surface of at least one of the two spaced apart elongate side girders, the catwalk assembly is configured to selectively move from a stowed position to a deployed position to increase width of the rigid upper deck.

In certain aspects, a catwalk assembly is attached to an outermost peripheral surface to each of the two spaced apart elongate side girders, the catwalk assembly is configured to selectively move from a stowed position to a deployed position to increase width of the rigid upper deck.

In certain aspects, the rigid lower deck includes two spaced apart elongate side girders that are connected by a planar, rigid material positioned there between, the planar, rigid material configured to support automobile(s) and/or transfer trucks thereon.

In certain aspects, each stanchion of the pair of vertically adjustable and horizontally rotatable stanchions are spaced apart relative to each other and are each connected to one elongate side girder of the rigid upper deck and a corresponding elongate rigid side girder of the lower deck, each stanchion of the pair of vertically adjustable and horizontally rotatable stanchions are horizontally rotatable from a coaxially aligned position relative to the elongate side girders to an axially offset position relative to the elongate side girders thereby increasing width of the rigid lower deck.

In certain aspects, each stanchion of the pair of vertically adjustable and horizontally rotatable stanchions are independently movable in which each stanchion of the pair of vertically adjustable and horizontally rotatable stanchions can be independently vertically adjusted and/or horizontally rotated relative to the other stanchion of the pair of vertically adjustable and horizontally rotatable stanchions.

In certain aspects, disclosed is a catwalk assembly configured for attachment to an elongate side girder of a transport trailer, the catwalk assembly including a ground link configured for mounting on the elongate side girder and including an actuating member; and a drive link including a plurality of spaced apart slats and guardrails that form a catwalk, the plurality of spaced apart slats and guardrails are operatively connected to the actuating member and are configured to move in unison from a stowed position immediately adjacent the elongate side girder to a deployed position (i.e., in a direction away from the elongate side girder and the upper and/or lower deck) when actuated by the actuating member.

In certain aspects, also disclosed is a stanchion assembly for a double decker transport trailer, the stanchion assembly includes an elongate beam configured for attachment to a lower deck of a transport trailer, the elongate beam having a first and second spaced apart ends; and two spaced apart vertically adjustable and horizontally rotatable stanchions, with a first vertically adjustable and horizontally rotatable stanchion attached to a first end of the elongate beam and a second vertically adjustable and horizontally rotatable stanchion attached to a second end of the elongate beam, wherein each stanchion is independently vertically adjustable and independently horizontally rotatable relative to each other.

In certain aspects, each stanchion of the above mentioned stanchion assembly is configured for attachment to an upper deck of a double decker transport trailer.

In certain aspects, each stanchion is configured to horizontally rotate relative to one another to increase distance between the two spaced apart vertically adjustable stanchions when in a deployed position.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of the transport trailer;

FIG. 2 is a magnified perspective view of the transport trailer of FIG. 1;

FIG. 3A depicts the catwalk/catwalk assembly in a deployed position relative to the elongate side girder of the upper deck of the transport trailer;

FIG. 3B depicts the catwalk being retracted from the deployed position into the stowed position relative to the elongate side girder of the upper deck of the transport trailer;

FIG. 4 depicts an exploded view of the catwalk assembly;

FIG. 5 depicts a perspective view of the assembled catwalk assembly (not attached to the transport trailer);

FIG. 6 depicts a magnified side view of transport trailer including the second pair of stanchions configured for vertical movement and rotational movement about a horizontal axis;

FIG. 7 depicts a perspective view of the second pair of stanchions configured for vertical movement and rotational movement about a horizontal axis;

FIG. 8 depicts an exploded view of the second pair of stanchions configured for vertical movement and rotational movement about a horizontal axis;

FIG. 9 depicts one of the second pair of stanchions in a stowed position in which the stanchion is axially aligned with the side girders of the upper and lower decks of the transport trailer; and

FIG. 10 depicts one of the second pair of stanchions rotated away from the upper and lower decks of the trailer such that the stanchion is axially offset from the side girders of the upper and lower decks of the transport trailer.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

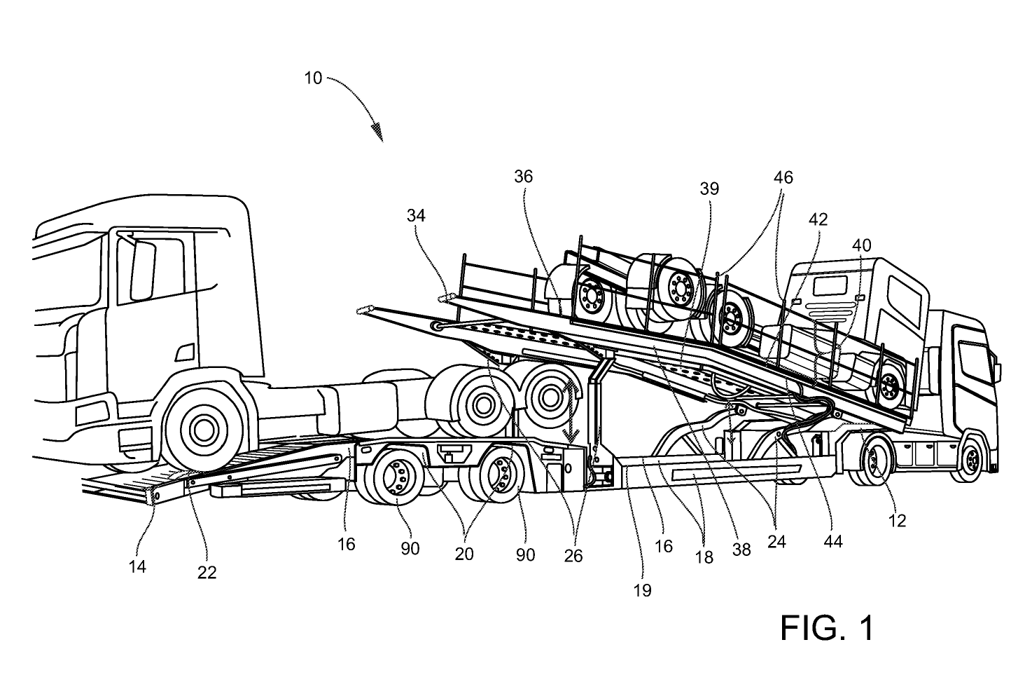

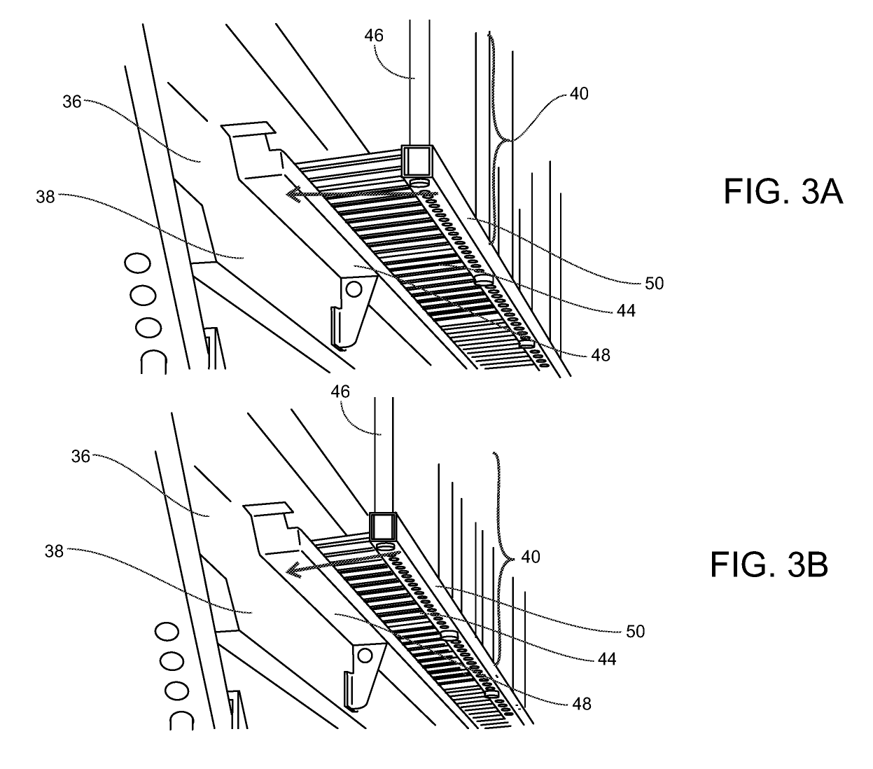

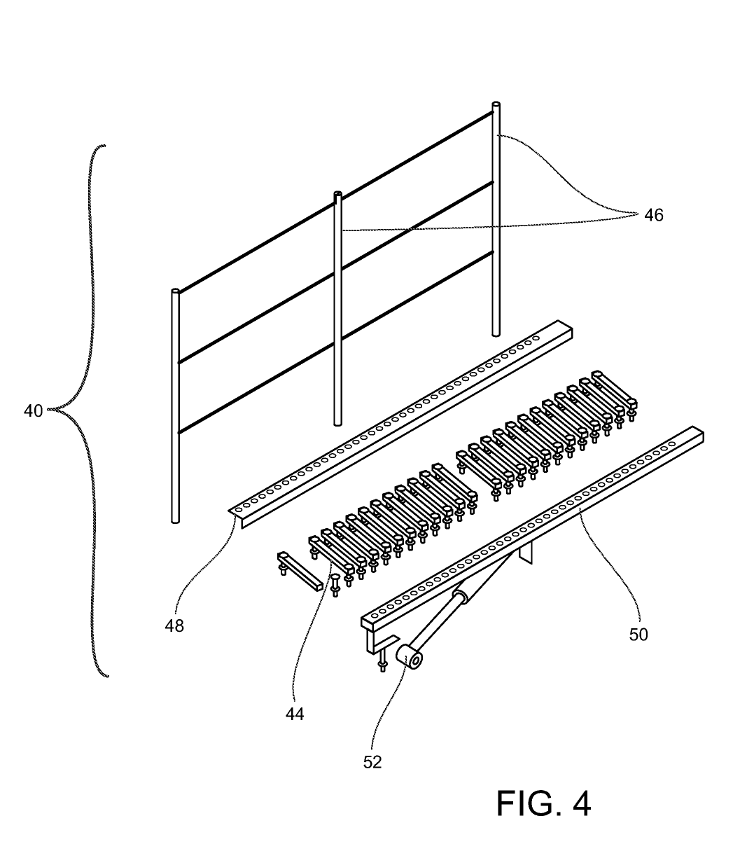

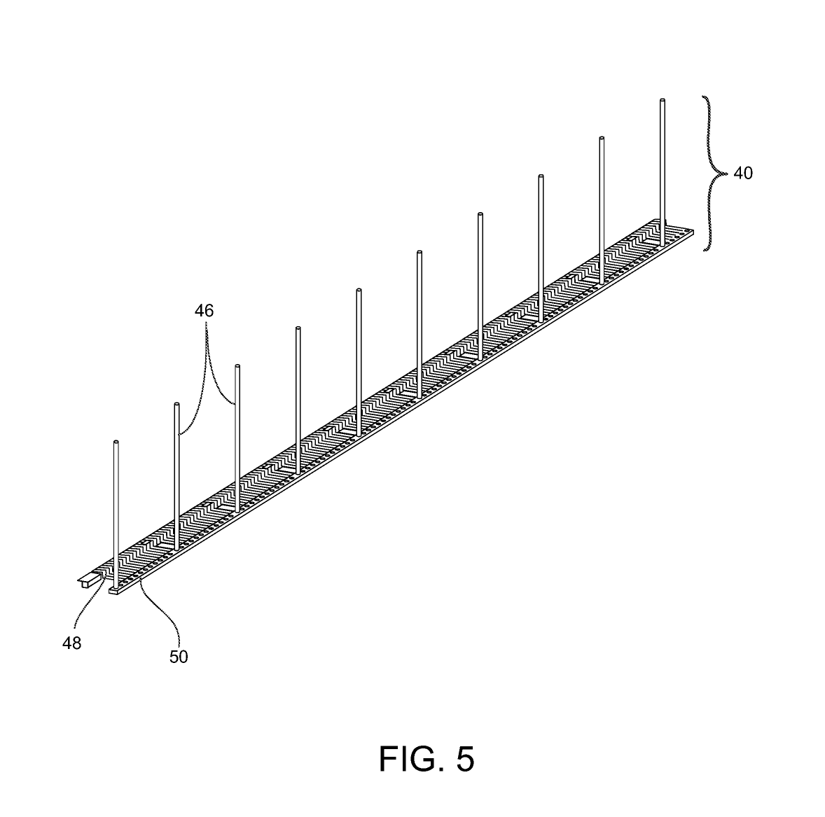

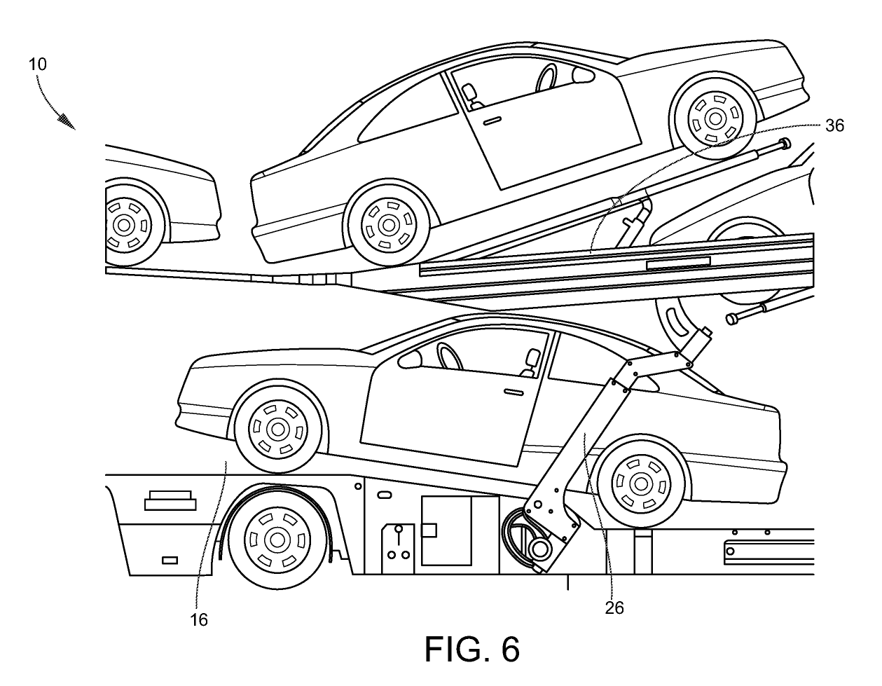

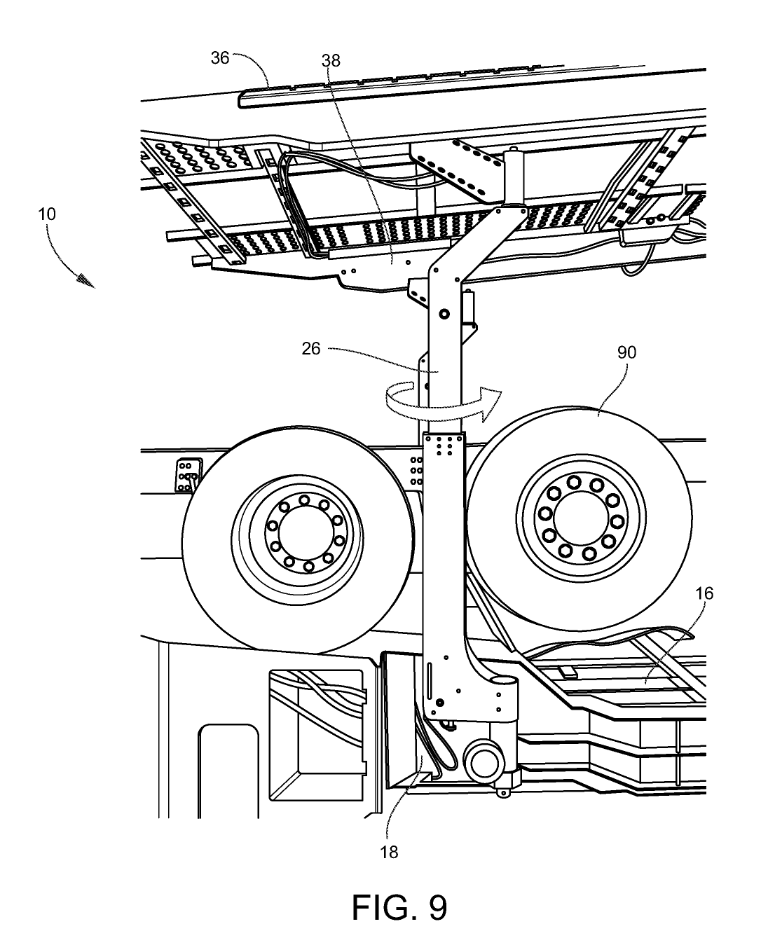

FIGS. 1-10 depict transport trailers 10 having upper 36 and lower 16 decks for securely positioning automobiles thereon for transportation and further having deployable and stowable components allowing easier user maneuverability to move about the trailer especially after parking the automobile thereon and when compared to conventional trailers. As discussed further below and as further depicted in FIGS. 3A-5 and FIGS. 7-10, these trailers 10 include a catwalk assembly 40 and/or stanchion assembly 25 having two spaced apart vertically adjustable and horizontally rotatable stanchions 26 respectively that each selectively increase the operable width of the upper 36 and/or lower 16 decks so that a user may more easily walk about and maneuver around the trailer 10 after parking an automobile or transfer truck thereon.

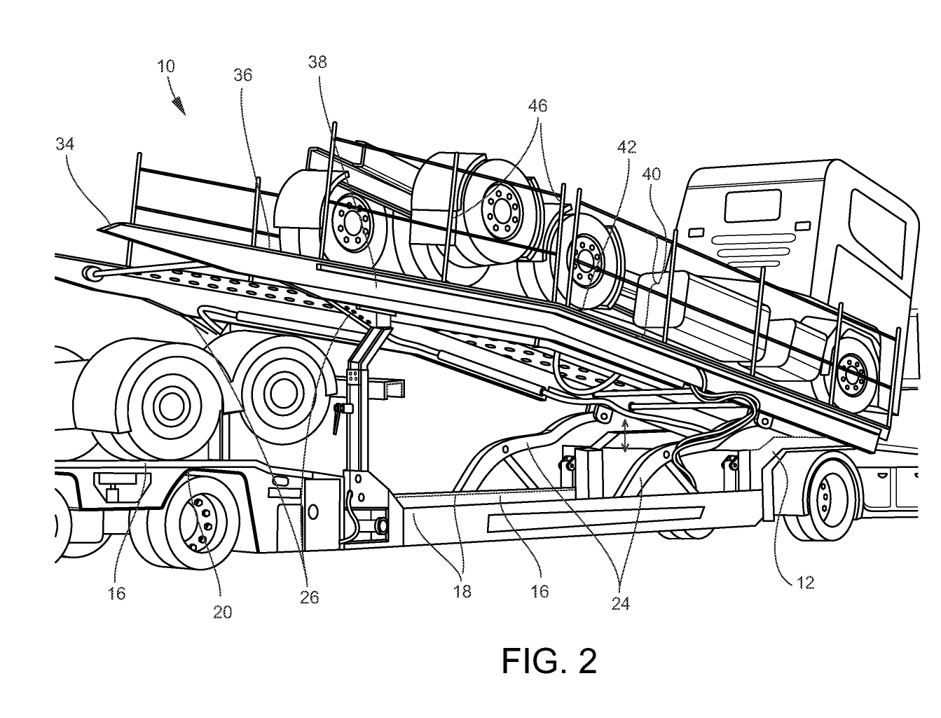

FIGS. 1 and 2 respectively provide a perspective and magnified perspective views of the trailers 10 disclosed herein. With specific reference to FIG. 1, trailer 10 includes a rigid lower deck 16 (also referred to herein as “lower deck”) and a rigid upper deck 36 (also referred to herein as “upper deck”) connected to each other by a first pair of vertically adjustable stanchions 24 and a second pair of vertically adjustable and horizontally rotatable stanchions 26 being spaced apart from the first pair of vertically adjustable stanchions.

The lower deck 16 includes a first end 12 configured for attachment to a movement means (e.g., a transfer truck) and a ramp 14 positioned at the opposite end of the lower deck relative to the first end. The first end 12 of the lower deck is preferably elevated relative to the ramp 14 and includes an attachment means (e.g., a tongue) for attaching to the movement means. The first end 12 may further include a jack that is deployed when trailer 10 is not attached to the movement means and/or transporting automobiles and/or transfer truck(s). The ramp 14 is inclined and is selectively adjustable to facilitate loading of the automobiles on the lower 16 and/or upper 36 decks.

The lower deck 16 is comprised of two spaced apart elongate side girders 18 that are connected by a planar, rigid material 19 positioned there between. The planar, rigid material is configured to support automobile(s) and/or transfer trucks thereon. In certain aspects, the planar, rigid material 19 can be rigid, metal slats, metal diamond plating, or a metal grate having sufficient strength to support automobile(s) and/or transfer trucks thereon. The lower deck 16 further includes wheel wells 20 with tires 90 connected by axles to allow for movement of the trailer 10 and further includes wheel chocks 22 interspersed throughout the lower deck 16, which may be selectively deployed to secure the automobile(s) and/or transfer truck(s) thereon.

As further shown in FIGS. 1 and 2 and similar to the lower deck 16, the rigid upper deck 36 also includes two spaced apart elongate side girders 38 that are connected by a planar, rigid material 39 positioned there between, the planar, rigid material is configured to support automobile(s) and/or transfer trucks. In certain aspects, the planar, rigid material 39 can be rigid, metal slats, metal diamond plating, or a metal grate having sufficient strength to support automobile(s) and/or transfer trucks thereon. Similar to the lower deck 16, the upper deck 36 further includes wheel chocks interspersed throughout the upper deck 36, which may be selectively deployed to secure the automobile(s) and/or transfer truck(s) thereon.

As further shown in FIGS. 1 and 2, the rigid upper deck 36 for parking and transporting automobiles and/or transfer trucks thereon is mounted/affixed to the rigid lower deck 16 by a first pair of vertically adjustable stanchions 24 proximate to the first end 12 of the rigid lower deck The rigid upper deck 36 has a first end that extends beyond the first end 12 of the rigid lower deck 16 and a ramp 34 positioned at the opposite end of the rigid upper deck 36 relative to a first end of the rigid upper deck. The first pair of vertically adjustable stanchions 24 are configured to selectively adjust distance (height) between the rigid upper deck 36 and rigid lower deck 16 and more particularly the distance between the first end 12 of the rigid lower deck 16 and the first end of the rigid upper deck 36.

As further shown in FIGS. 1 and 2, the rigid upper deck 36 for parking and transporting automobiles and/or transfer trucks thereon is also mounted/affixed to the rigid lower deck 16 by a pair of vertically adjustable and horizontally rotatable stanchions 26 that are spaced apart from the first pair of vertically adjustable stanchions 24. The pair of vertically adjustable and horizontally rotatable stanchions 26 are spaced farther from the first end 12 of the rigid lower deck 16 when compared to the first pair of vertically adjustable stanchions 24 but are more proximate to the ramp 34 of the upper deck relative to the first pair of vertically adjustable stanchions and ramp 34.

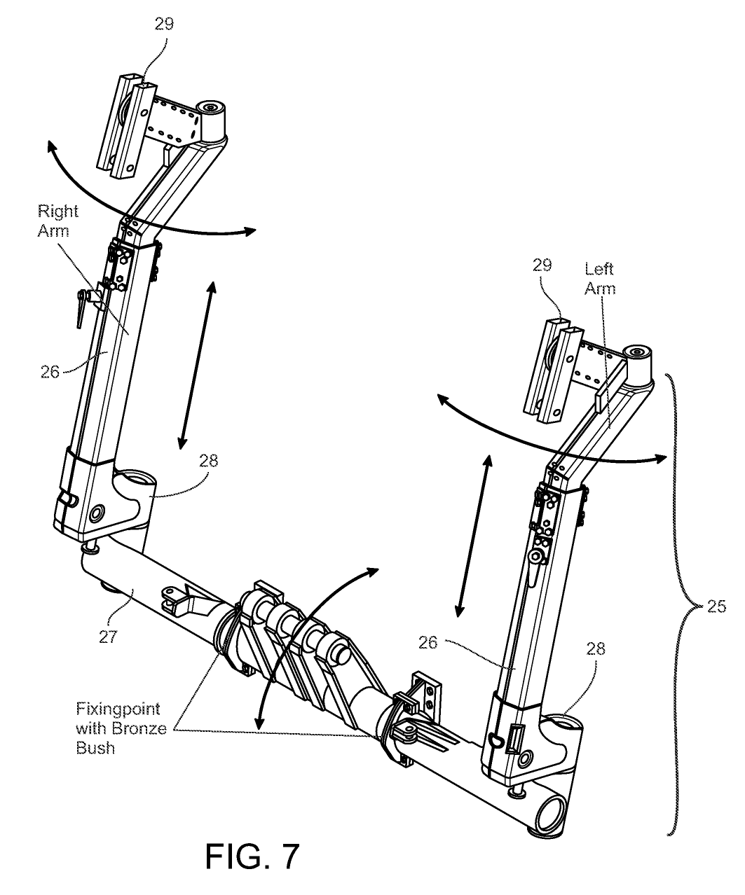

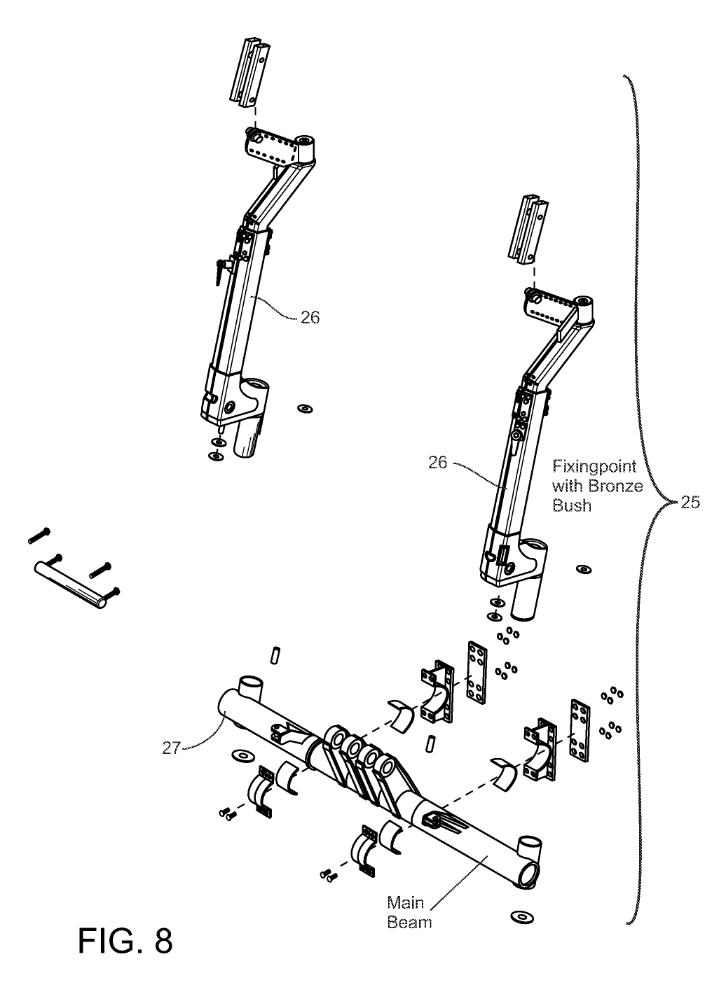

Each stanchion of vertically adjustable and horizontally rotatable stanchions 26 are spaced apart relative to each other and are each connected to one, elongate side girder 38 on opposite sides of the rigid upper deck 36 by a connection member 29 and each stanchion 26 is further connected to a corresponding elongate rigid side girder 18 of the lower deck 16. With specific reference to FIGS. 7 and 8, a stanchion assembly 25 is shown. In certain aspects, the stanchion assembly 25 is attached to trailer 10. The stanchion assembly 25 includes an elongate beam 27 configured for attachment to a lower deck 16 of a transport trailer 10. For example, the elongate beam 27 is affixed to and transversely extends through the lower deck 16 of the transport trailer 10. In certain aspects and in view of FIGS. 7-9, the elongate beam 27 has first and second spaced apart ends 28 with a stanchion of the pair of vertically adjustable and horizontally rotatable stanchions 26 attached thereto.

It should be noted that each stanchion of the pair of vertically adjustable and horizontally rotatable stanchions 26 is independently vertically adjustable and independently horizontally rotatable relative to each other. Vertical adjustment of the pair of vertically adjustable and horizontally rotatable stanchions allows for selectively adjusting the distance (height) between the rigid upper deck 36 and rigid lower deck 16 and more particularly the distance between ramp 34 of the rigid upper deck 36 and the rigid lower deck 16.

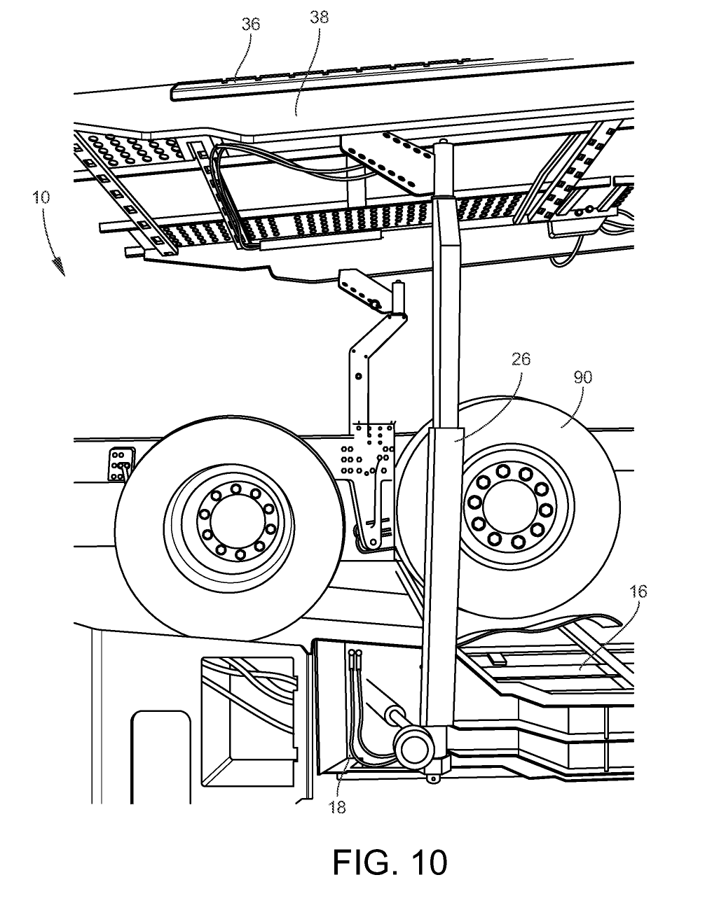

In view of FIGS. 1, 2, 9, and 10, it should be further noted that each stanchion of the pair of vertically adjustable and horizontally rotatable stanchions 26 independently horizontally rotates relative to each other in a direction away from the upper 36 and lower 16 decks. For example and as shown in FIGS. 1, 2, and 9, each stanchion of the pair of vertically adjustable and horizontally rotatable stanchions 26 are initially coaxially aligned relative to the elongate side girders 18, 38 of the upper 36 and lower 16 decks (stowed position), and as further shown in FIG. 10 (especially when view in relation to tire 90), each stanchion of the pair of vertically adjustable and horizontally rotatable stanchions 26 is configured to deploy away from the upper 36 and lower 16 deck in an axially offset position (deployed position) relative to the elongate side girders 18, 38 of the lower and upper decks thereby increasing width of the rigid lower deck. The increased width of the rigid lower deck 16 resulting from the deployed position of the pair of vertically adjustable and horizontally rotatable stanchions 26 advantageously allows one to more easily move about the lower deck 16 of trailer 10 after parking the automobile thereon.

As further shown in FIGS. 3A, 3B, 4, and 5, the trailers 10 include a catwalk assembly 40 attached thereto. The catwalk assembly 40 is configured for attachment to an elongate side girder 18, 38 of the transport trailer 10 and includes a ground link 48 configured for mounting on the elongate side girder 18, 38 and a drive link 50 including a plurality of spaced apart slats 44 and guardrails 46 that form a catwalk 42. The ground link 48 further includes an actuating member that is operatively connected to the drive link and is configured to move the plurality of spaced apart slats 44 and guardrails 46 in unison from a stowed position to a deployed position (i.e., in a direction away from the elongate side girder 18, 38) when actuated by the actuating member. When the catwalk assembly 40 is fully deployed, each slat of the plurality of spaced apart slats 44 are perpendicular relative to the drive link 50 and elongate side girder 18, 38 along the longitudinal axis of the trailer 10. In certain aspects, a user may want to partially deploy the drive link 50 in order to slightly increase deck width. In this instance, the plurality of spaced apart slats 44 will be slightly angled (acute angle), but not perpendicular, relative to the drive link 50 and elongate side girder 18, 38 along the longitudinal axis of the trailer 10.

In view of the above description, FIG. 3A specifically depicts the catwalk/catwalk assembly 42, 40 in a deployed position (substantially fully deployed) relative to the upper deck 36 of the transport trailer, and FIG. 3B further depicts the catwalk 42 being retracted (partially deployed) in which the plurality of spaced apart slats 44 and guardrails 46 are moving in unison from the deployed position into the stowed position relative to the upper deck 36 of the transport trailer 10. As further shown in FIG. 3A, when the catwalk assembly 40 is deployed, overall width of the deck (e.g., the upper deck 36) is increased thereby allowing for easier user maneuverability to move about the trailer especially after parking the automobile thereon.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.
10 Transport Trailer
12 First End; Elevated Forward End Configured for attachment to movement means
14 Ramp of Lower Deck
16 Lower Deck
18 Side Girders (of Lower Deck)
19 Planar, Rigid Material (of Lower Deck)
20 Wheel Wells with tires connected by axles
22 Wheel Chock
24 First Pair of Vertically Adjustable Stanchions
25 Stanchion Assembly
26 Second Pair of Vertically Adjustable and Horizontally Rotatable Stanchions
27 Elongate Beam
28 Connection point between elongate beam and stanchion
29 Connection point between stanchion and upper deck of trailer
34 Second Ramp Connected to Lower Deck
36 Upper Deck
38 Side Girders (of Upper Deck)
39 Planar, Rigid Material (of Upper Deck)
40 Catwalk Assembly
42 Walkway/catwalk
44 Plurality of Slats connected to Side Girders of Upper Deck that form Walkway
46 Guardrails
48 Ground link
50 drive link (w/elongate mounting bracket)
52 Actuating Member (e.g., that provides translational movement between the drive link relative to the ground link moving the catwalk and plurality of connected slats simultaneously between deployed and stowed positions)
90 Tire(s)

What is claimed is:

1. A transport trailer configured to transport automobiles and/or transfer trucks thereon, the trailer comprising:
(a) a rigid lower deck for parking and transporting automobiles and/or transfer trucks thereon, the lower deck having a first end configured for attachment to a movement means and a ramp positioned at the opposite end of the lower deck relative to the first end that is configured to receive and load automobiles and/or transfer trucks thereon;
(b) a rigid upper deck for parking and transporting automobiles and/or transfer trucks thereon that is mounted onto the rigid lower deck by a first pair of vertically adjustable stanchions proximate to the first end of rigid lower deck and a second pair of vertically adjustable and horizontally rotatable stanchions that are spaced apart from the first pair of vertically adjustable stanchions along the longitudinal axis of the trailer, the rigid upper deck having a first end that extends beyond the first end of the rigid lower deck and a ramp positioned at the opposite end of the rigid upper deck relative to a first end of the rigid upper deck that is vertically adjustable by the second pair of vertically adjustable and horizontally rotatable stanchions to load automobiles thereon.

2. The transport trailer of claim 1, wherein the rigid upper deck comprises two spaced apart elongate side girders that are connected by a planar, rigid material positioned there between, the planar, rigid material is configured to support automobile(s) and/or transfer trucks thereon.

3. The transport trailer of claim 2, wherein a catwalk assembly is attached to an outermost peripheral surface of at least one of the two spaced apart elongate side girders, the catwalk assembly is configured to selectively move from a stowed position to a deployed position to increase width of the rigid upper deck.

4. The transport trailer of claim 1, wherein a catwalk assembly is attached to an outermost peripheral surface to each of the two spaced apart elongate side girders, the catwalk assembly is configured to selectively move from a stowed position to a deployed position to increase width of the rigid upper deck.

5. The transport trailer of claim 4, wherein the rigid lower deck comprises two spaced apart elongate side girders that are connected by a planar, rigid material positioned there between, the planar, rigid material configured to support automobile(s) and/or transfer trucks thereon.

6. The transport trailer of claim 5, wherein each stanchion of the pair of vertically adjustable and horizontally rotatable stanchions are spaced apart relative to each other and are each connected to one elongate side girder of the rigid upper deck and a corresponding elongate rigid side girder of the lower deck, each stanchion of the pair of vertically adjustable and horizontally rotatable stanchions are horizontally rotatable from a coaxially aligned position relative to the elongate side girders to an axially offset position relative to the elongate side girders to increase width of the rigid lower deck.

7. The transport trailer of claim 6, wherein each stanchion of the pair of vertically adjustable and horizontally rotatable stanchions are independently vertically adjustable and/or horizontally rotatable relative to each other.

8. A catwalk assembly configured for attachment to an elongate side girder of a transport trailer, the catwalk assembly comprising:
a ground link configured for mounting on the elongate side girder and including an actuating member; and
a drive link including a plurality of spaced apart slats and guardrails defining a catwalk, the plurality of spaced apart slats and guardrails are operatively connected to the actuating member and are configured to move in unison from a stowed position to a deployed position when actuated by the actuating member.

9. A stanchion assembly for a double decker transport trailer, the stanchion assembly comprising:
an elongate beam configured for attachment to a lower deck of a transport trailer, the elongate beam have a first and second spaced apart ends;
two spaced apart vertically adjustable and horizontally rotatable stanchions, with a first vertically adjustable and horizontally rotatable stanchion attached to a first end of the elongate beam and a second vertically adjustable and horizontally rotatable stanchion attached to a second end of the elongate beam, wherein
each stanchion is independently vertically adjustable and independently horizontally rotatable relative to each other.

10. The stanchion assembly of claim 9, wherein each stanchion is configured for attachment to an upper deck of a double decker transport trailer.

11. The stanchion assembly of claim 9, wherein each stanchion is configured to horizontally rotate relative to one another to increase distance between the two spaced apart vertically adjustable stanchions when in a deployed position.
